(19) United States
(12) Patent Application Publication
(10) Pub. No.: US 2017/0279393 A1
(43) Pub. Date: Sep. 28, 2017

(54) INVERTER CONTROLLER AND ON-VEHICLE FLUID MACHINE

(71) Applicant: KABUSHIKI KAISHA TOYOTA JIDOSHOKKI, Kariya-shi (JP)

(72) Inventors: Takashi KAWASHIMA, Kariya-shi (JP); Yoshiki NAGATA, Kariya-shi (JP); Masahiko HIRANO, Kariya-shi (JP)

(73) Assignee: KABUSHIKI KAISHA TOYOTA JIDOSHOKKI, Kariya-shi (JP)

(21) Appl. No.: 15/468,575

(22) Filed: Mar. 24, 2017

(30) Foreign Application Priority Data
Mar. 28, 2016 (JP) 2016-064207

(51) Int. Cl. H02P 21/22; H02P 6/18; B60H 1/32; H02P 27/08

(52) U.S. Cl. CPC H02P 21/22; H02P 27/08; H02P 6/18; B60H 1/3205; B60H 1/3222; B60H 2001/3292

(57) ABSTRACT

An inverter controller is used to control an inverter circuit that drives an electric motor including a rotor and a stator. The inverter controller includes a voltage detector configured to detect input voltage, a current detector configured to detect motor current, an instruction value calculation unit configured to calculate an instruction value based on an external instruction value and a detection result of the current detector, a correction unit configured to calculate a corrected instruction value by correcting the instruction value in accordance with the input voltage, a PWM control unit configured to control the motor current based on the corrected instruction value and the input voltage, and a position estimation unit configured to estimate a rotation position of the rotor based on the instruction value and the detection result of the current detector.

### TECHNICAL FIELD

The present invention relates to an inverter controller installed in an on-vehicle fluid machine and to the on-vehicle fluid machine.

### BACKGROUND ART

A known inverter controller installed in an on-vehicle fluid machine is used to control an inverter circuit that drives an electric motor including a rotor, which includes permanent magnets, and a stator, around which a coil is wound (refer to, for example, Japanese Laid-Open Patent Publication No. 2015-208187). The inverter controller described in Japanese Laid-Open Patent Publication No. 2015-208187 includes a current detector that detects motor current flowing to the electric motor, an instruction value calculation unit that calculates an instruction value based on external instruction values provided from an external device to the electric motor and a detection result of the current detector, and a PWM (pulse-width modulation) controller that performs PWM control on a switching element of the inverter circuit based on, for example, an input voltage and an instruction value of the inverter circuit. Further, Japanese Laid-Open Patent Publication No. 2015-208187 describes that a rotation speed and a rotation position of the rotor are estimated without using a rotation position sensor such as a resolver and that a rotation position of the rotor is estimated based on the detection result of the current detector and the instruction value.

### SUMMARY OF THE INVENTION

For example, noise generated at the inverter circuit may cause the input voltage to fluctuate. This may result in the voltage that is actually applied to the coil of the electric motor to be erroneous and differ from the voltage that corresponds to the instruction value. This causes the current estimated from the instruction value to be erroneous and differ from the detection result of the current detector indicating the actual current flowing to the coil, which occurs when the input voltage fluctuates because of noise. That is, the fluctuation of the input voltage caused by noise may result in the detection result of the current detector being deviated from the corresponding instruction value. In this case, the input voltage fluctuation caused by noise may lower the accuracy of the estimated rotor rotation position, which is based on the instruction value and the detection result of the current detector.

Further, the inverter controller is installed in the on-vehicle fluid machine. In this case, the input voltage of the inverter circuit may vary between different vehicle types. Thus, it is desirable that the inverter controller be applicable to different input voltages for different vehicle types while limiting decreases in the estimation accuracy.

It is an object of the present invention to provide an inverter controller and an on-vehicle fluid machine including the inverter controller that limit decreases in the accuracy for estimating the rotation position of a rotor even when the input voltage fluctuates.

An inverter controller that achieves the above object is used to control an inverter circuit that drives an electric motor including a rotor, which includes a permanent magnet, and a stator, around which a coil is wound. The inverter controller is configured to be installed in an on-vehicle fluid machine. The inverter controller includes a voltage detector configured to detect input voltage of the inverter circuit, a current detector configured to detect motor current that flows to the electric motor, an instruction value calculation unit configured to calculate an instruction value based on an external instruction value provided from an external device to the electric motor and a detection result of the current detector, a correction unit configured to calculate a corrected instruction value by correcting the instruction value in accordance with the input voltage, a PWM control unit configured to control the motor current by performing PWM control on a switching element arranged in the inverter circuit based on the corrected instruction value and the input voltage, and a position estimation unit configured to estimate a rotation position of the rotor based on the instruction value and the detection result of the current detector.

An on-vehicle fluid machine that achieves the above object includes the inverter controller, an inverter device including an inverter circuit controlled by the inverter controller, and an electric motor driven by the inverter circuit.

An inverter controller that achieves the above object is used to control an inverter circuit that drives an electric motor including a rotor, which includes a permanent magnet, and a stator, around which a coil is wound. The inverter controller is configured to be installed in an on-vehicle fluid machine. The inverter controller includes a voltage sensor configured to detect input voltage of the inverter circuit, a current sensor configured to detect motor current that flows to the electric motor, and a processor. The processor is configured to calculate an instruction value based on an external instruction value provided from an external device to the electric motor and a detection result of the current sensor, calculate a corrected instruction value by correcting the instruction value in accordance with the input voltage, control the motor current by performing PWM control on a switching element arranged in the inverter circuit based on the corrected instruction value and the input voltage, and estimate a rotation position of the rotor based on the instruction value and the detection result of the current sensor.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of an inverter controller, an on-vehicle electric compressor, an on-vehicle air conditioner, and a vehicle;

FIG. 2 is a block circuit diagram showing the electrical configuration of a first embodiment of an inverter device and an inverter controller;

FIG. 3 is a graph showing the relationship of the input voltage and the correction coefficient;

FIG. 4 is a graph schematically showing a u-phase output voltage waveform; and

FIG. 5 is a block circuit diagram showing the electrical configuration of a second embodiment of an inverter device and an inverter controller.

### EMBODIMENTS OF THE INVENTION

### First Embodiment

A first embodiment of an inverter controller, an on-vehicle fluid machine including the inverter controller, and a vehicle will now be described. In the present embodiment, the on-vehicle fluid machine is an on-vehicle electric compressor used with an on-vehicle air conditioner.

The on-vehicle air conditioner and the on-vehicle electric compressor will now be described.

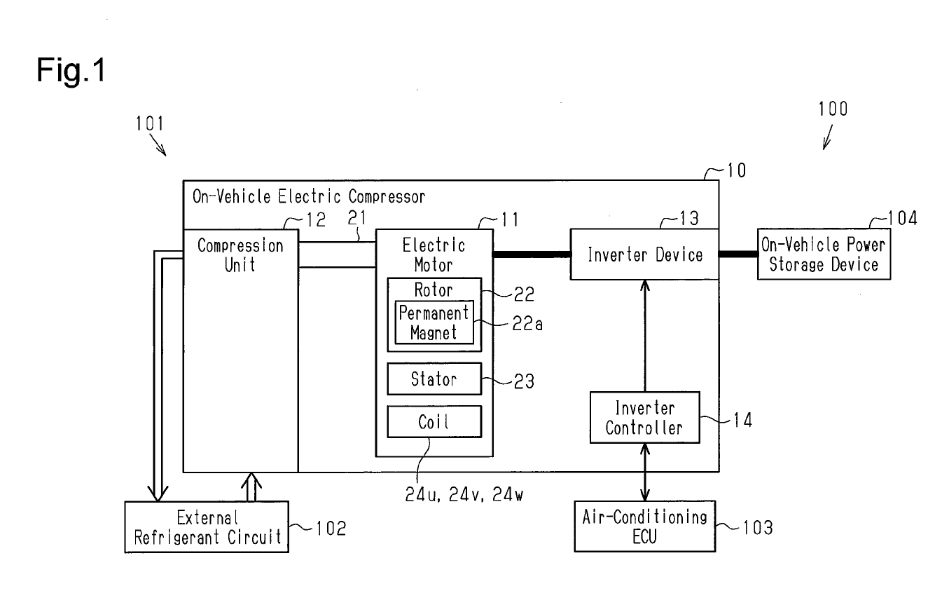

As shown in FIG. 1, an on-vehicle air conditioner 101 is installed in a vehicle 100. The on-vehicle air conditioner 101 includes an on-vehicle electric compressor 10 and an external refrigerant circuit 102 that supplies refrigerant, which serves as fluid, to the on-vehicle electric compressor 10.

The external refrigerant circuit 102 includes, for example, a heat exchanger and an expansion valve. The on-vehicle air conditioner 101 uses the on-vehicle electric compressor 10 to compress refrigerant and the external refrigerant circuit 102 to exchange heat with the refrigerant and expand the refrigerant. This cools and heats the passenger compartment.

The on-vehicle air conditioner 101 includes an air-conditioning ECU 103 that controls the entire on-vehicle air conditioner 101. The air-conditioning ECU 103 is configured to acquire, for example, a passenger compartment temperature and a preset temperature of the vehicle air conditioner. Based on these parameters, the air-conditioning ECU 103 transmits various instructions such as activation and deactivation instructions to the on-vehicle electric compressor 10.

The vehicle 100 includes an on-vehicle power storage device 104. The on-vehicle power storage device 104 may be any device that is configured to be charged by direct current power and discharge direct current power, for example, a rechargeable battery or an electric double-layer capacitor. The on-vehicle power storage device 104 is used as a power supply for the on-vehicle electric compressor 10.

Although not illustrated in the drawings, the on-vehicle power storage device 104 is electrically connected to on-vehicle devices other than the on-vehicle electric compressor 10 and supplies the other on-vehicle devices with power. Accordingly, noise that leaks from the other on-vehicle devices may be transmitted to the on-vehicle electric compressor 10. The on-vehicle device is, for example, a power control unit.

The on-vehicle electric compressor 10 includes an electric motor 11, a compression unit 12, an inverter device 13 that drives the electric motor 11, and an inverter controller 14 used to control the inverter device 13. The inverter controller 14 may include, for example, circuitry, that is, at least one dedicated hardware circuit such as an application-specific integrated circuit (ASIC), at least one processing circuit that operates according to a computer program (software), or a combination of these. The processing circuit includes a CPU and memories (ROM, RAM, and the like), which store programs executed by the CPU. The memories, or computer readable media, include any type of media that are accessible by general-purpose computers and dedicated computers.

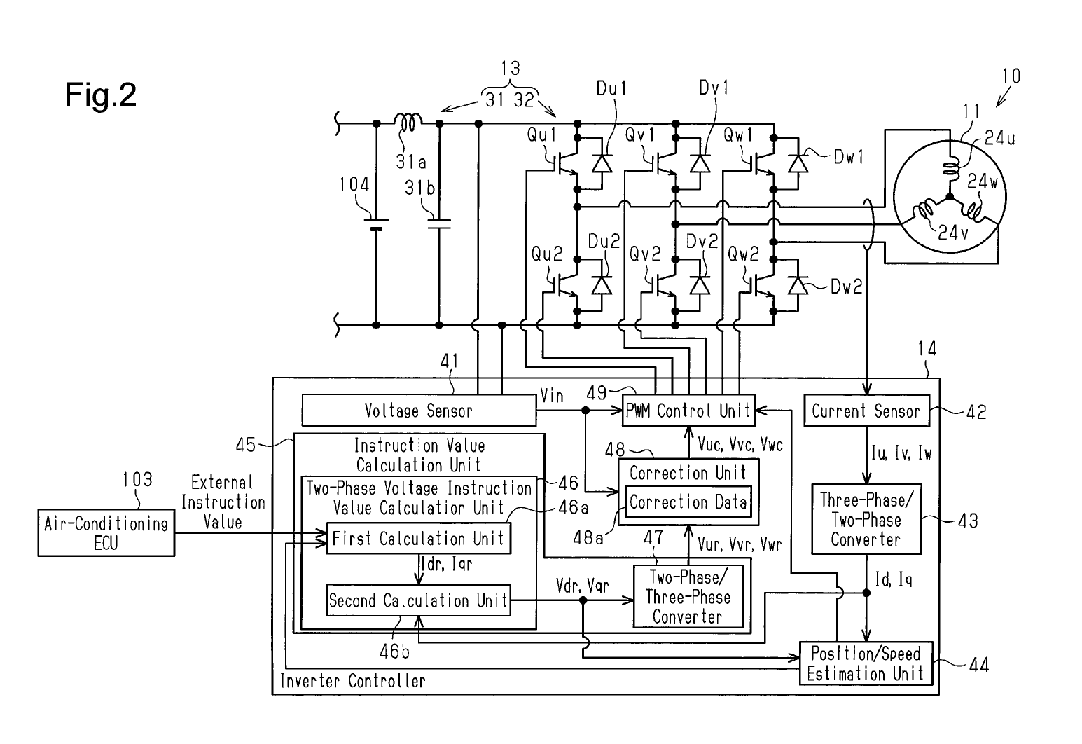

The electric motor 11 includes a rotation shaft 21, a rotor 22 fixed to the rotation shaft 21, a stator 23 opposed to the rotor 22, and three-phase coils 24u, 24v, and 24w wound around the stator 23. The rotor 22 includes permanent magnets 22a. More specifically, the permanent magnets 22a are embedded in the rotor 22. As shown in FIG. 2, the coils 24u, 24v, and 24w form a Y-connection. The rotor 22 and the rotation shaft 21 rotate when current flows to each of the coils 24u, 24v, and 24w in a predetermined pattern. That is, the electric motor 11 of the present embodiment is a three-phase motor.

The compression unit 12 compresses refrigerant when the electric motor 11 is driven. More specifically, when the rotation shaft 21 rotates, the compression unit 12 compresses refrigerant drawn from the external refrigerant circuit 102 and discharges the compressed refrigerant. The specific structure of the compression unit 12 may be of, for example, a scroll type, a piston type, or a vane type.

As shown in FIG. 2, the inverter device 13 includes a filter circuit 31 (i.e., noise reduction circuit) that reduces noise and an inverter circuit 32 that receives direct current power from noise that has been reduced by the filter circuit 31.

The filter circuit 31 is, for example, an LC resonant circuit including an inductor 31a and a capacitor 31b. The filter circuit 31 reduces noise (hereinafter referred to as inflow noise) included in the direct current power that is received from the on-vehicle power storage device 104 in a frequency band that is lower than the resonant frequency of the filter circuit 31.

Inflow noise may be, for example, produced when a switching element is switched in another on-vehicle device that shares the on-vehicle power storage device 104 with the on-vehicle electric compressor 10.

The frequency of the inflow noise varies in accordance with the vehicle type. In the present embodiment, the resonant frequency of the filter circuit 31 is set to be higher than the frequency band expected to include inflow noise in different types of vehicles to which the on-vehicle electric compressor 10 may be applied. That is, the resonant frequency of the filter circuit 31 of the present embodiment is set to be enough to be applicable to multiple vehicle types.

The filter circuit 31 may have any specific configuration. For example, the filter circuit 31 may be of a n-type or T-type and include capacitors 31b or inductors 31a. Alternatively, the inductor 31a may be omitted. In this case, a parasitic inductor of the capacitor 31b is used to form the filter circuit 31 (resonant circuit). Further, there may be one or more filter circuits 31.

The inverter circuit 32 converts direct current power, which is received from the filter circuit 31, into alternating current power. The inverter circuit 32 includes u-phase switching elements Qu1 and Qu2 corresponding to the u-phase coil 24u, v-phase switching elements Qv1 and Qv2 corresponding to the v-phase coil 24v, and w-phase switching elements Qw1 and Qw2 corresponding to the w-phase coil 24w.

Each of the switching elements Qu1, Qu2, Qv1, Qv2, Qw1, and Qw2 (hereinafter referred to as “the switching elements Qu1 to Qw2”) is a power switching element such as an IGBT. However, each of the switching elements Qu1 to Qw2 does not have to be an IGBT. The switching elements Qu1 to Qw2 include freewheeling diodes Du1 to Dw2 (body diodes), respectively.

The u-phase switching elements Qu1 and Qu2 are connected to each other in series by a connection wire, which is connected to the u-phase coil 24u. The first u-phase switching element Qu1 includes a collector that is connected to a positive electrode of the on-vehicle power storage device 104 via the filter circuit 31. The second u-phase switching element Qu2 includes an emitter that is connected to a negative electrode of the on-vehicle power storage device 104 via the filter circuit 31.

Although the corresponding coils are different, the other switching elements Qv1, Qv2, Qw1, and Qw2 are connected in the same manner as the u-phase switching elements Qu1 and Qu2.

The inverter controller 14 controls a switching operation of the inverter device 13, more specifically, the switching elements Qu1 to Qw2. The inverter controller 14 is electrically connected to the air-conditioning ECU 103 and cyclically activates and deactivates the switching elements Qu1 to Qw2 based on external instruction values that are provided from an external device to the electric motor 11 (in the present embodiment, instruction value from air-conditioning ECU 103).

The inverter controller 14 includes a voltage sensor 41, which serves as a voltage detector, and a current sensor 42, which serves as a current detector. The voltage sensor 41 detects input voltage Vin of the inverter circuit 32. The current sensor 42 detects motor current that flows to the electric motor 11. The input voltage Vin may be the voltage input to the inverter device 13, the voltage of the on-vehicle power storage device 104, and the power supply voltage.

The inverter controller 14 includes a three-phase/two-phase converter 43 that converts three-phase currents Iu, Iv, and Iw detected by the current sensor 42 into a d-axis current Id and a q-axis current Iq (hereinafter referred to as “the two-phase currents Id and Iq”) that are orthogonal to each other. The inverter controller 14 uses the three-phase/two-phase converter 43 to acquire the two-phase currents Id and Iq.

The motor current refers to the three-phase currents Iu, Iv, and Iw, which respectively flow to the coils 24u, 24v, and 24w for the three phases, or the two-phase currents Id and Iq, which are obtained by performing three-phase/two-phase conversion on the three-phase currents Iu, Iv, and Iw.

The d-axis current Id refers to the current of a component in the axial direction of magnetic flux of the rotor 22, that is, the excitation component current. The q-axis current Iq refers to a torque component current that is related to the torque of the electric motor 11.

The inverter controller 14 includes a position/speed estimation unit 44 (position estimation unit) that estimates the rotation position and the rotation speed of the rotor 22 and an instruction value calculation unit 45 that calculates an instruction value used to control the inverter circuit 32.

The position/speed estimation unit 44 estimates a rotation position and a rotation speed of the rotor 22 based on the instruction value and the two-phase currents Id and Iq obtained by the three-phase/two-phase converter 43, which will be described later.

The instruction value calculation unit 45 calculates, as instruction values, two-phase voltage instruction values Vdr and Vqr and three-phase voltage instruction values Vur, Vvr, and Vwr based on external instruction values from the air-conditioning ECU 103 and the two-phase currents Id and Iq obtained by the three-phase/two-phase converter 43.

The two-phase voltage instruction values Vdr and Vqr include a d-axis voltage instruction value Vdr and a q-axis voltage instruction value Vqr. The d-axis voltage instruction value Vdr is a target value of the voltage applied to the d-axis of the electric motor 11, and the q-axis voltage instruction value Vqr is a target value of the voltage applied to the q-axis of the electric motor 11.

The three-phase voltage instruction values Vur, Vvr, and Vwr include a u-phase voltage instruction value Vur, a v-phase voltage instruction value Vvr, and a w-phase voltage instruction value Vwr. The u-phase voltage instruction value Vur is a target value of the voltage applied to the u-phase coil 24u, the v-phase voltage instruction value Vvr is a target value of the voltage applied to the v-phase coil 24v, and the w-phase voltage instruction value Vwr is a target value of the voltage applied to the w-phase coil 24w.

The instruction value calculation unit 45 includes a two-phase voltage instruction value calculation unit 46 and a two-phase/three-phase converter 47.

The two-phase voltage instruction value calculation unit 46 calculates the two-phase voltage instruction values Vdr and Vqr based on the external instruction values, the two-phase currents Id and Iq, and an estimation value of a rotation speed from the position/speed estimation unit 44.

More specifically, the two-phase voltage instruction value calculation unit 46 includes a first calculation unit 46a and a second calculation unit 46b.

The first calculation unit 46a calculates the current instruction values Idr and Iqr based on the external instruction values and an estimation value of a rotation speed from the position/speed estimation unit 44.

The external instruction value is, for example, a rotation speed instruction value. For example, the air-conditioning ECU 103 obtains the necessary flow rate of the refrigerant from an operation condition or the like of the on-vehicle air conditioner 101 and obtains a rotation speed that achieves the flow rate. The air-conditioning ECU 103 outputs the obtained rotation speed to the first calculation unit 46a as the external instruction value.

The external instruction value is not limited to a rotation speed instruction value and may have any specific instruction content that specifies a drive mode of the electric motor 11. Further, a subject to which the external instruction value is output does not necessarily have to be the air-conditioning ECU 103.

The second calculation unit 46b calculates the two-phase voltage instruction values Vdr and Vqr based on the two-phase current instruction values Idr and Iqr calculated by the first calculation unit 46a and the two-phase currents Id and Iq obtained by the three-phase/two-phase converter 43. The two-phase voltage instruction values Vdr and Vqr are transmitted to the two-phase/three-phase converter 47 and the position/speed estimation unit 44.

The two-phase/three-phase converter 47 performs two-phase/three-phase conversion on the two-phase voltage instruction values Vdr and Vqr, which are provided from the two-phase voltage instruction value calculation unit 46 (more specifically, second calculation unit 46b), to convert the two-phase voltage instruction values Vdr and Vqr into the three-phase voltage instruction values Vur, Vvr, and Vwr.

The inverter controller 14 includes a correction unit 48 and a PWM control unit 49. The correction unit 48 calculates three-phase corrected voltage instruction values Vuc, Vvc, and Vwc as corrected instruction values by correcting the three-phase voltage instruction values Vur, Vvr, and Vwr. The PWM control unit 49 performs PWM (pulse width modulation) control on each of the switching elements Qu1 to Qw2.

The correction unit 48 corrects the three-phase voltage instruction values Vur, Vvr, and Vwr in accordance with the input voltage Vin. More specifically, the correction unit 48 includes correction data 48a that shows the corresponding relationship of the input voltage Vin and a correction coefficient K. The correction unit 48 refers to the correction data 48a to acquire the input voltage Vin from a detection result of the voltage sensor 41 and acquires the correction coefficient K corresponding to the input voltage Vin. Further, the correction unit 48 obtains the three-phase corrected voltage instruction values Vuc, Vvc, and Vwc by multiplying each of the three-phase voltage instruction values Vur, Vvr, and Vwr by the correction coefficient K.

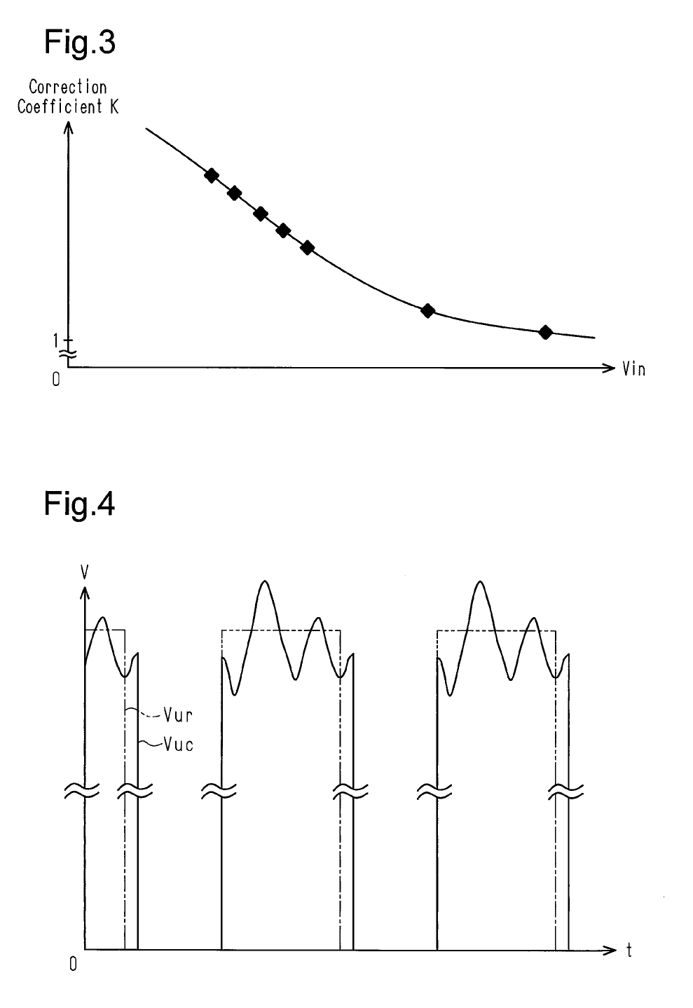

As shown in FIG. 3, the correction coefficient K is set to be greater than or equal to “1.” In the present embodiment, the correction coefficient K is set to increase as the input voltage Vin decreases. The relationship of the input voltage Vin and the correction coefficient K is calculated in advance through, for example, tests and simulations.

The PWM control unit 49 controls the motor current (three-phase currents Iu, Iv, and Iw) that flows to the electric motor 11 by performing PWM control on each of the switching elements Qu1 to Qw2 based on the input voltage Vin, the three-phase corrected voltage instruction values Vuc, Vvc, and Vwc, and a rotation position estimated by the position/speed estimation unit 44. More specifically, the PWM control unit 49 generates a PWM signal based on the three-phase corrected voltage instruction values Vcu, Vvc, and Vwc received from the correction unit 48, the input voltage Vin, the estimated position of the rotor 22 from the position/speed estimation unit 44, and a carrier signal. The PWM control unit 49 uses the PWM signal to perform a switching operation on each of the switching elements Qu1 to Qw2. This allows the two-phase currents Id and Iq, which are equal to or substantially equal to the current instruction values Idr and Iqr, to flow to the electric motor 11. The carrier frequency, which is a frequency of a carrier, is higher than the frequency band of inflow noise.

Actually, the inverter controller 14 performs feedback control so that the two-phase currents Id and Iq flowing to the electric motor 11 approach the current instruction values Idr and Iqr, respectively. The control of the current instruction values Idr and Iqr means that the two-phase currents Id and Iq flowing to the electric motor 11 are controlled.

In such a configuration, the position/speed estimation unit 44 of the present embodiment estimates the rotation position and the rotation speed of the rotor 22 based on the detection result of the current sensor 42 (more specifically, two-phase currents Id and Iq obtained by three-phase/two-phase converter 43) and at least one of the two-phase voltage instruction values Vdr and Vqr. More specifically, the position/speed estimation unit 44 obtains an induction voltage, which is induced in each of the coils 24u, 24v, and 24w, based on, for example, the two-phase currents Id and Iq, the d-axis voltage instruction value Vdr, and a motor constant. Further, the position/speed estimation unit 44 estimates the rotation position and the rotation speed of the rotor 22 based on, for example, the induction voltage and the d-axis current Id. The position/speed estimation unit 44 does not have to perform estimation in the manner described above and may perform estimation in any manner.

The position/speed estimation unit 44 acquires detection results of the voltage sensor 41 and the current sensor 42 on a regular basis and estimates the rotation position and the rotation speed of the rotor 22 on a regular basis. This allows the position/speed estimation unit 44 to follow changes in the rotation position and the rotation speed of the rotor 22, and the estimation values of the rotation position and the rotation speed respectively approach the actual rotation position and the actual rotation speed.

The operation of the present embodiment will now be described with reference to FIG. 4. FIG. 4 is a graph that illustrates the operation of the present embodiment. In FIG. 4, the solid lines show a u-phase output voltage waveform based on the u-phase corrected voltage instruction value Vuc, and the broken lines show a u-phase output voltage waveform based on the u-phase voltage instruction value Vur of an ideal state in which the input voltage Vin does not fluctuate.

In the present embodiment, the resonant frequency of the filter circuit 31 is set to be relatively high so that the resonant frequency of the filter circuit 31 is applicable to multiple vehicle types. Thus, inflow noise included in direct current power input to the inverter device 13 is reduced by the filter circuit 31 in a wide frequency band. The resonant frequency of the filter circuit 31 approaches the carrier frequency.

When each of the switching elements Qu1 to Qw2 of the inverter circuit 32 is switched, noise is generated at the inverter circuit 32. The noise includes carrier frequency noise and a harmonic component of the carrier frequency noise. Under a situation in which the resonant frequency of the filter circuit 31 is set to be relatively high (i.e., resonant frequency is close to carrier frequency) as described above, the filter circuit 31 does not function to filter the noise. Thus, the noise affects the input voltage Vin. More specifically, the input voltage Vin will include ripple (noise) that fluctuates the input voltage Vin. Thus, the u-phase output voltage fluctuates as shown in FIG. 4. In this case, as compared to when the input voltage Vin does not fluctuate, the output voltage will be insufficient, and the u-phase voltage Vu that is actually applied to the u-phase coil 24u will be smaller than the u-phase voltage instruction value Vur.

In this regard, the present embodiment corrects the u-phase voltage instruction value Vur with the correction unit 48 and generates a u-phase PWM signal based on the u-phase voltage corrected instruction value Vuc. As shown in FIG. 4, this increases the pulse width and compensates for the insufficient amount of output voltage when the input voltage Vin fluctuates. Accordingly, the u-phase voltage Vu approaches the u-phase voltage instruction value Vur.

The same applies to the v-phase and the w-phase as the u-phase. In other words, the correction unit 48 calculates the three-phase corrected voltage instruction values Vuc, Vvc, and Vwc in correspondence with fluctuation of the input voltage Vin that results from ripple. Thus, the three-phase voltages Vu, Vv, and Vw respectively approach (preferably, correspond to) the three-phase voltage instruction values Vur, Vvr, and Vwr that were set prior to correction.

In the present embodiment, the three-phase voltages Vu, Vv, and Vw are affected by ripple and respectively become smaller than the three-phase voltage instruction values Vur, Vvr, and Vwr. Thus, the correction coefficient K is set to be greater than or equal to “1.”

Further, the range in which the input voltage Vin varies between different vehicle types is, for example, several hundred volts, which is larger than the range in which the input voltage Vin is fluctuated by ripple. The correction coefficient K is set, for example, in the range from 1 to 1.2 in correspondence with the range in which the input voltage Vin varies between different vehicle types. Thus, the correction coefficient K is hardly affected by fluctuation of the input voltage Vin caused by ripple.

The present embodiment has the advantages described below.

(1) The electric motor 11 includes the rotor 22, which includes the permanent magnets 22a, and the stator 23, around which the coils 24u, 24v, 24w are wound. The inverter controller 14 is used to control the inverter circuit 32 that drives the electric motor 11. The inverter controller 14 includes the voltage sensor 41 that detects the input voltage Vin of the inverter circuit 32 and the current sensor 42 that detects the motor current (three-phase currents Iu, Iv, and Iw) flowing to the electric motor 11. The inverter controller 14 includes the instruction value calculation unit 45 that calculates the two-phase voltage instruction values Vdr and Vqr and the three-phase voltage instruction values Vur, Vvr, and Vwr based on external instruction values (rotation speed instruction values) provided from an external device to the electric motor 11 and a detection result of the current sensor 42 (more specifically, two-phase currents Id and Iq obtained by performing three-phase/two-phase conversion on detection result). The inverter controller 14 includes the correction unit 48 that calculates the three-phase corrected voltage instruction values Vuc, Vvc, and Vwc by correcting the three-phase voltage instruction values Vur, Vvr, and Vwr in accordance with the input voltage Vin. The inverter controller 14 includes the PWM control unit 49 that controls motor current by performing PWM control on the switching elements Qu1 to Qw2 of the inverter circuit 32 based on the three-phase corrected voltage instruction values Vuc, Vvc, and Vwc and the input voltage Vin. The inverter controller 14 includes the position/speed estimation unit 44 that estimates a rotation position of the rotor 22 based on the voltage instruction value that was set prior to correction and the detection result of the current sensor 42.

In such a configuration, PWM control is performed on the switching elements Qu1 to Qw2 based on the three-phase corrected voltage instruction values Vuc, Vvc, and Vwc. Thus, even when the input voltage Vin fluctuates when the switching elements Qu1 to Qw2 of the inverter circuit 32 are switched, voltages that are close to the three-phase voltage instruction values Vur, Vvr, and Vwr are applied to the coils 24u, 24v, and 24w for the three phases. That is, voltages corresponding to the three-phase voltage instruction values Vur, Vvr, and Vwr are applied to the coils 24u, 24v, and 24w for the three phases. Thus, the three-phase voltage instruction values Vur, Vvr, and Vwr substantially correspond to the detection result of the current sensor 42 even when ripple (noise) fluctuates the input voltage Vin. This reduces estimation errors of the rotation position of the rotor 22 that occur when the input voltage Vin fluctuates because of ripple (noise).

More specifically, since the PWM control unit 49 uses the input voltage Vin to control the switching elements Qu1 to Qw2, the three-phase voltage instruction values Vur, Vvr, and Vwr may differ from the voltages (three-phase voltages Vu, Vv, and Vw) that are actually applied to the coils 24u, 24v, and 24w for the three phases when ripple fluctuates the input voltage Vin. Further, the three-phase currents Iu, Iv, and Iw detected by the current sensor 42 respectively correspond to the three-phase voltages Vu, Vv, and Vw that are actually applied and do not correspond to the three-phase voltage instruction values Vur, Vvr, and Vwr. The position/speed estimation unit 44 estimates the rotation position of the rotor 22 based on the instruction values that were set prior to correction (for example, two-phase voltage instruction values Vdr and Vqr, from which three-phase voltage instruction values Vur, Vvr, and Vwr are converted) and the two-phase currents Id and Iq, which are obtained by converting the three-phase currents Iu, Iv, and Iw. In such a state, the errors between the three-phase voltage instruction values Vur, Vvr, and Vwr and the three-phase voltages Vu, Vv, and Vw change the corresponding relationship of the three-phase voltage instruction values Vur, Vvr, and Vwr and the two-phase currents Id and Iq. Further, fluctuation of the input voltage Vin caused by ripple results in errors between the estimated position of the rotor 22 and an actual rotation position of the rotor 22. This may reduce the controllability of the electric motor 11.

In particular, in the configuration that performs PWM control, the errors between the three-phase voltage instruction values Vur, Vvr, and Vwr and the three-phase voltages Vu, Vv, and Vw tend to increase as the input voltage Vin decreases. That is, the degree of deviation in the corresponding relationship of the instruction value and the detection result of the current sensor 42 fluctuates in accordance with the input voltage Vin.

In this regard, in the present embodiment, the three-phase corrected voltage instruction values Vuc, Vvc, and Vwc are calculated by correcting the three-phase voltage instruction values Vur, Vvr, and Vwr in accordance with the input voltage Vin, and the PWM control unit 49 performs control based on the three-phase corrected voltage instruction values Vuc, Vvc, and Vwc. Thus, the three-phase voltage instruction values Vur, Vvr, and Vwr that were set prior to correction respectively approach the three-phase voltages Vu, Vv, and Vw that are actually applied regardless of the input voltage Vin. This limits decreases in the estimation accuracy of the rotation position of the rotor 22 that occur when the input voltage Vin fluctuates because of ripple. Further, even when the input voltage of the inverter circuit 32 is varied in accordance with, for example, differences in the specification of the on-vehicle power storage device 104, decreases in the estimation accuracy of the rotation position of the rotor 22 are limited. This increases the versatility of the inverter controller 14.

(2) The position/speed estimation unit 44 follows the fluctuation of the input voltage Vin caused by ripple. In this regard, the detection cycle of the voltage sensor 41 may be set to be shorter than the switching cycle of each of the switching elements Qu1 to Qw2. However, a shorter detection cycle of the voltage sensor 41 may increase the processing load on the inverter controller 14, and the inverter controller 14 will require a higher processing capacity. The present embodiment copes with fluctuation of the input voltage Vin without shortening the detection cycle of the voltage sensor 41.

(3) The electric motor 11 is a three-phase motor including the three-phase coils 24u, 24v, and 24w. The instruction value calculation unit 45 includes the two-phase voltage instruction value calculation unit 46 that calculates the two-phase voltage instruction values Vdr and Vqr based on the external instruction values and the two-phase currents Id and Iq. Further, the instruction value calculation unit 45 includes the two-phase/three-phase converter 47 that performs two-phase/three-phase conversion on the two-phase voltage instruction values Vdr and Vqr into the three-phase voltage instruction values Vur, Vvr, and Vwr.

In such a configuration, the correction unit 48 calculates the three-phase corrected voltage instruction values Vuc, Vvc, Vwc by correcting the three-phase voltage instruction values Vur, Vvr, and Vwr in accordance with the input voltage Vin. The PWM control unit 49 performs PWM control on each of the switching elements Qu1 to Qw2 based on the three-phase corrected voltage instruction values Vuc, Vvc, and Vwc, the input voltage Vin, and the rotation position of the rotor 22 estimated by the position/speed estimation unit 44. The position/speed estimation unit 44 estimates the rotation position of the rotor 22 based on at least one of the two-phase voltage instruction values Vdr and Vqr (for example, d-axis voltage instruction value Vdr) and the detection result of the current sensor 42 (more specifically, two-phase currents Id and Iq).

In such a configuration, the correction unit 48 corrects the three-phase voltage instruction values Vur, Vvr, and Vwr. This compensates for errors between the three-phase voltage instruction values Vur, Vvr, and Vwr and the three-phase voltages Vu, Vv, and Vw that occur when the input voltage Vin fluctuates because of ripple. As a result, the two-phase voltage instruction values Vdr and Vqr correspond to the detection result of the current sensor 42. That is, deviation in the corresponding relationship of the two-phase voltage instruction values Vdr and Vqr and the detection result of the current sensor 42 that occurs when the input voltage Vin is fluctuated by ripple is compensated. This reduces the influence of the errors, which occur when the input voltage Vin fluctuates because of ripple, in the rotation position of the rotor 22 estimated by the position/speed estimation unit 44 based on at least one of the two-phase voltage instruction values Vdr and Vqr and the detection result of the current sensor 42. Accordingly, decreases in the estimation accuracy of the rotation position of the rotor 22 that occur when the input voltage Vin fluctuates because of ripple are limited.

(4) The correction unit 48 multiplies each of the three-phase voltage instruction values Vur, Vvr, and Vwr by the correction coefficient K. This allows the correction unit 48 to perform correction relatively easily.

Further, errors between the three-phase voltage instruction values Vur, Vvr, and Vwr and the three-phase voltages Vu, Vv, and Vw tend to increase as the input voltage Vin decreases. In accordance with this tendency, the correction coefficient K is set to increase as the input voltage Vin decreases. Accordingly, the errors between the three-phase voltage instruction values Vur, Vvr, and Vwr and the three-phase voltages Vu, Vv, and Vw remain within a constant range regardless of the input voltage Vin. This limits decreases in the estimation accuracy of the rotation position of the rotor 22 even when the voltage input to the inverter device 13 (inverter circuit 32) varies, for example, in accordance with the vehicle type.

(5) The correction unit 48 includes the correction data 48a that shows the corresponding relationship of the correction coefficient K and the input voltage Vin. The correction unit 48 refers to the correction data 48a to acquire the correction coefficient K corresponding to the input voltage Vin. This allows the correction unit 48 to correct the three-phase voltage instruction values Vur, Vvr, and Vwr without performing complicated calculations.

(6) The on-vehicle electric compressor 10 serving as the on-vehicle fluid machine includes the inverter controller 14, the inverter device 13 that includes the inverter circuit 32 controlled by the inverter controller 14, and the electric motor 11 driven by the inverter circuit 32. The inverter device 13 includes the filter circuit 31 that reduces inflow noise included in direct current power that is received from the outside of the inverter device 13 (on-vehicle electric compressor 10). The inverter circuit 32 receives direct current power in which inflow noise has been reduced by the filter circuit 31 and converts the direct current power into alternating current power.

In such a configuration, since inflow noise included in direct current power is reduced by the filter circuit 31, the influence of the inflow noise is reduced in the inverter circuit 32. This limits decreases in the controllability of the inverter circuit 32 that are caused by inflow noise.

It is preferred that the frequency band of inflow noise that can be reduced by the filter circuit 31 be widened to increase versatility. Thus, the resonant frequency of the filter circuit 31 may be increased to widen the frequency band of inflow noise that can be reduced. However, when the resonant frequency of the filter circuit 31 is increased, the filter circuit 31 does not function to filter noise generated in the inverter circuit 32. Thus, for example, the noise may not be reduced sufficiently. In particular, since the noise has a frequency that is close to the resonant frequency of the filter circuit 31, resonance occurs in the filter circuit 31 and amplifies the noise. This reduces the estimation accuracy of the rotation position of the rotor 22. That is, the inventors of the present invention have noticed that when the versatility is improved to reduce inflow noise in a wide frequency band, the noise (ripple) generated in the inverter circuit 32 fluctuates the input voltage Vin and lowers the estimation accuracy of the rotation position of the rotor 22.

In this regard, the present embodiment corrects the three-phase voltage instruction values Vur, Vvr, and Vwr taking into account fluctuation of the input voltage Vin caused by ripple as described above. Thus, there is no need for changing the hardware configuration by, for example, adding a damping resistor to maintain the estimation accuracy. This increases the versatility and limits decreases in the estimation accuracy of the rotation position of the rotor 22 without a complicated hardware configuration.

### Second Embodiment

In the first embodiment, the three-phase voltage instruction values Vur, Vvr, and Vwr are subject to correction. In the second embodiment, the two-phase voltage instruction value Vdr and Vqr are subject to correction. The following description focuses on the configuration that differs from the first embodiment. In the second embodiment, like or same reference numerals are given to those components that are the same as the corresponding components of the first embodiment. Such components will not be described in detail.

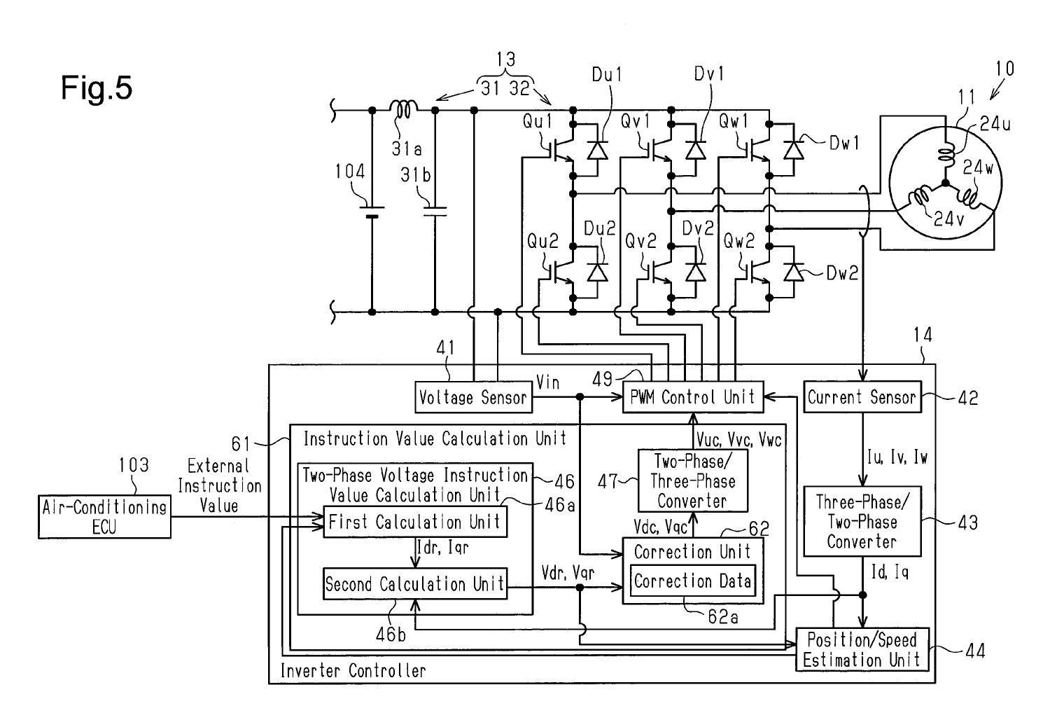

As shown in FIG. 5, the second embodiment includes an instruction value calculation unit 61. The instruction value calculation unit 61 includes a correction unit 62 arranged between the two-phase voltage instruction value calculation unit 46 and the two-phase/three-phase converter 47. The correction unit 62 calculates the two-phase corrected voltage instruction values Vdc and Vqc by correcting the two-phase voltage instruction values Vdr and Vqr in accordance with the input voltage Vin and outputs the two-phase corrected voltage instruction values Vdc and Vqc to the two-phase/three-phase converter 47.

The correction unit 62 includes correction data 62a in which the two-phase voltage instruction values Vdr and Vqr and the input voltage Vin correspond to the two-phase corrected voltage instruction values Vdc and Vqc. The correction unit 62 refers to the correction data 62a to calculate the two-phase corrected voltage instruction values Vdc and Vqc corresponding to the two-phase voltage instruction values Vdr and Vqr and the input voltage Vin that are received.

The two-phase corrected voltage instruction values Vdc and Vqc are set taking into account ripple of the input voltage Vin so that the voltages obtained by performing three-phase/two-phase conversion on the three-phase voltages Vu, Vv, and Vw, which are actually applied to the coils 24u, 24v, and 24w for the three phases, approach (preferably, correspond to) the two-phase voltage instruction values Vdr and Vqr. That is, the correction unit 62 of the second embodiment calculates the two-phase corrected voltage instruction values Vdc and Vqc in correspondence with fluctuation of the input voltage Vin caused by ripple so that the two-phase voltage instruction values Vdr and Vqr approach the d-axis voltage and the q-axis voltage that are actually applied to the electric motor 11. The two-phase corrected voltage instruction values Vdc and Vqc are voltage instruction values corresponding to the detection result of the current sensor 42.

Further, the two-phase/three-phase converter 47 of the second embodiment converts the two-phase corrected voltage instruction values Vdc and Vqc into the three-phase corrected voltage instruction values Vuc, Vvc, and Vwc.

The position/speed estimation unit 44 estimates the rotation position of the rotor 22 based on at least one of the two-phase voltage instruction values Vdr and Vqr (for example, d-axis voltage instruction value Vdr) and the two-phase currents Id and Iq.

The second embodiment has the advantages described below.

(7) The instruction value calculation unit 61 includes the two-phase voltage instruction value calculation unit 46, the correction unit 62 that calculates the two-phase corrected voltage instruction values Vdc and Vqc by correcting the two-phase voltage instruction values Vdr and Vqr in accordance with the input voltage Vin, and the two-phase/three-phase converter 47 that converts the two-phase corrected voltage instruction values Vdc and Vqc into the three-phase corrected voltage instruction values Vuc, Vvc, and Vwc. The position/speed estimation unit 44 estimates the rotation position of the rotor 22 based on at least one of the two-phase voltage instruction values Vdr and Vqr (for example, d-axis voltage instruction value Vdr) and the detection result of the current sensor 42 (more specifically, two-phase currents Id and Iq). Even in such a configuration, advantage (1) and the like are obtained. That is, the correction unit 62 corrects the two-phase voltage instruction values Vdr and Vqr to compensate for deviation in the corresponding relationship of the two-phase voltage instruction values Vdr and Vqr and the detection result of the current sensor 42 that occur when the input voltage Vin is fluctuated by ripple. Thus, when the position/speed estimation unit 44 estimates the rotation position of the rotor 22, the influence of fluctuation of the input voltage Vin that is caused by noise is reduced. This limits decreases in the estimation accuracy of the rotation position of the rotor 22 that occur when the input voltage Vin fluctuates because of noise.

The instruction values that are subject to correction may be the three-phase voltage instruction values Vur, Vvr, and Vwr or the two-phase voltage instruction values Vdr and Vqr. However, when the three-phase voltage instruction values Vur, Vvr, and Vwr are corrected like in the first embodiment, the voltage instruction values are corrected without taking two-phase/three-phase conversion into account. Thus, correction is performed relatively easily in such a configuration.

It should be apparent to those skilled in the art that the present invention may be embodied in many other specific forms without departing from the spirit or scope of the invention. Particularly, it should be understood that the present invention may be embodied in the following forms.

The correction unit 48 of the first embodiment may use a value other than “1” as the correction coefficient K when the input voltage Vin is less than a predetermined threshold value voltage and use “1” as the correction coefficient K when the input voltage Vin is greater than or equal to the threshold value voltage. That is, the inverter controller 14 may be configured not to correct the three-phase voltage instruction values Vur, Vvr, and Vwr when the input voltage Vin is greater than or equal to the threshold value voltage. Thus, when fluctuation of the input voltage Vin caused by ripple has little influence, the processing load is reduced by omitting correction. The same applies to the second embodiment. Even in this case, the correction unit corrects an instruction value in accordance with the input voltage Vin.

In this modified example, the correction coefficient K may be changed in accordance with the input voltage Vin or may be a constant value when the input voltage Vin is less than the predetermined threshold value voltage.

Errors between the three-phase voltage instruction values Vur, Vvr, and Vwr and the three-phase voltages Vu, Vv, and Vw may decrease depending on a mounting condition or the like as the input voltage Vin decreases. In this case, it is preferred that the correction coefficient K be set to decrease as the input voltage Vin decreases. More specifically, the correction coefficient K may approach “1” as the input voltage Vin decreases.

The correction coefficient K may be changed in a stepped manner or in a linear manner. That is, the correction coefficient K may be changed in any manner. Further, the correction data 48a and 62a may have any specific form such as map data and function data.

The current instruction values Idr and Iqr may be used as instruction values that are subject to correction. In this case, the correction unit is arranged between the first calculation unit 46a and the second calculation unit 46b to correct the two-phase current instruction values Idr and Iqr and output the corrected values to the second calculation unit 46b.

The correction units 48 and 62 may perform correction in any manner. For example, the correction units 48 and 62 may be configured to add or subtract a variable value that changes in accordance with the input voltage Vin.

The filter circuit 31 may be omitted.

The inverter device 13 and the inverter controller 14 may be integrated into a single unit.

The on-vehicle electric compressor 10 does not have to be used with the on-vehicle air conditioner 101 and may be used with other devices. For example, when the vehicle 100 is a fuel-cell vehicle, the on-vehicle electric compressor 10 may be used with an air supply device that supplies a fuel cell with air. That is, the fluid that is compressed is not limited to refrigerant and may be air. Even in this case, the controllability of the on-vehicle fluid machine is increased by limiting decreases in the estimation accuracy of the rotation position of the rotor 22 that occur when the input voltage Vin fluctuates.

The on-vehicle fluid machine is not limited to the on-vehicle electric compressor 10 including the compression unit 12 that compresses fluid. For example, when the vehicle 100 is a fuel-cell vehicle, the on-vehicle fluid machine may be an electric pump device including a pump, which supplies a fuel cell with hydrogen without compressing the hydrogen, and an electric motor, which drives the pump. In this case, the inverter device 13 controlled by the inverter controller 14 may be used for the electric motor that drives the pump.

Each of the above embodiments and each of the modified examples may be combined.

Therefore, the present examples and embodiments are to be considered as illustrative and not restrictive and the invention is not to be limited to the details given herein, but may be modified within the scope and equivalence of the appended claims.

1. An inverter controller used to control an inverter circuit that drives an electric motor including a rotor, which includes a permanent magnet, and a stator, around which a coil is wound, wherein the inverter controller is configured to be installed in an on-vehicle fluid machine, the inverter controller comprising:
a voltage detector configured to detect input voltage of the inverter circuit;
a current detector configured to detect motor current that flows to the electric motor;
an instruction value calculation unit configured to calculate an instruction value based on an external instruction value provided from an external device to the electric motor and a detection result of the current detector;
a correction unit configured to calculate a corrected instruction value by correcting the instruction value in accordance with the input voltage;
a PWM control unit configured to control the motor current by performing PWM control on a switching element arranged in the inverter circuit based on the corrected instruction value and the input voltage; and
a position estimation unit configured to estimate a rotation position of the rotor based on the instruction value and the detection result of the current detector.

2. The inverter controller according to claim 1, wherein
the electric motor is a three-phase motor including coils for three phases,
the instruction value calculation unit includes:
a two-phase voltage instruction value calculation unit configured to calculate a d-axis voltage instruction value applied to a d-axis of the electric motor and a q-axis voltage instruction value applied to a q-axis of the electric motor based on the external instruction value and the detection result of the current detector; and
a two-phase/three-phase converter configured to convert a two-phase voltage instruction value including the d-axis voltage instruction value and the q-axis voltage instruction value into a three-phase voltage instruction value,
the correction unit is configured to calculate a three-phase corrected voltage instruction value as the corrected instruction value by correcting the three-phase voltage instruction value in accordance with the input voltage,
the PWM control unit is configured to perform PWM control on the switching element based on the three-phase corrected voltage instruction value, the input voltage, and the estimation result of the position estimation unit, and
the position estimation unit is configured to estimate the rotation position of the rotor based on the detection result of the current detector and at least one of the d-axis voltage instruction value and the q-axis voltage instruction value.

3. The inverter controller according to claim 2, wherein
the correction unit is configured to obtain the three-phase corrected voltage instruction value by multiplying the three-phase voltage instruction value by a correction coefficient, and
the correction coefficient is set to increase as the input voltage decreases.

4. The inverter controller according to claim 2, wherein
the correction unit is configured to obtain the three-phase corrected voltage instruction value by multiplying the three-phase voltage instruction value by a correction coefficient, and
the correction coefficient is set to decrease as the input voltage decreases.

5. The inverter controller according to claim 1, wherein
the electric motor is a three-phase motor including coils for three phases,
the instruction value calculation unit includes a two-phase voltage instruction value calculation unit configured to calculate a d-axis voltage instruction value applied to a d-axis of the electric motor and a q-axis voltage instruction value applied to a q-axis of the electric motor based on the external instruction value and the detection result of the current detector,
the correction unit is configured to calculate a two-phase corrected voltage instruction value by correcting a two-phase voltage instruction value including the d-axis voltage instruction value and the q-axis voltage instruction value in accordance with the input voltage,
the instruction value calculation unit includes a two-phase/three-phase converter configured to convert the two-phase corrected voltage instruction value into a three-phase corrected voltage instruction value,
the PWM control unit is configured to perform PWM control on the switching element based on the three-phase corrected voltage instruction value, the input voltage, and the estimation result of the position estimation unit, and
the position estimation unit is configured to estimate the rotation position of the rotor based on the detection result of the current detector and at least one of the d-axis voltage instruction value and the q-axis voltage instruction value.

6. The inverter controller according to claim 1, wherein
the instruction value is a voltage instruction value, and
the correction unit is configured to calculate the corrected instruction value in correspondence with fluctuation of the input voltage so that voltage applied to the coil approaches the voltage instruction value.

7. An on-vehicle fluid machine comprising:
the inverter controller according to claim 1;
an inverter device including an inverter circuit controlled by the inverter controller; and
an electric motor driven by the inverter circuit.

8. The on-vehicle fluid machine according to claim 7, wherein
the inverter device includes a filter circuit configured to reduce inflow noise that is included in direct current power received from an external device, and
the inverter circuit receives the direct current power in which the inflow noise has been reduced by the filter circuit, wherein the inverter circuit is configured to convert the direct current power into alternating current power.

9. The on-vehicle fluid machine according to claim 7, wherein the on-vehicle fluid machine is an on-vehicle electric compressor including a compression unit that is configured to compress fluid when the electric motor is driven.

10. An inverter controller used to control an inverter circuit that drives an electric motor including a rotor, which includes a permanent magnet, and a stator, around which a coil is wound, wherein the inverter controller is configured to be installed in an on-vehicle fluid machine, the inverter controller comprising:
a voltage sensor configured to detect input voltage of the inverter circuit;
a current sensor configured to detect motor current that flows to the electric motor; and
a processor configured to:
calculate an instruction value based on an external instruction value provided from an external device to the electric motor and a detection result of the current sensor;
calculate a corrected instruction value by correcting the instruction value in accordance with the input voltage;
control the motor current by performing PWM control on a switching element arranged in the inverter circuit based on the corrected instruction value and the input voltage; and
estimate a rotation position of the rotor based on the instruction value and the detection result of the current sensor.
